(19) United States
(12) Patent Application Publication
(10) Pub. No.: US 2007/0080072 A1
(43) Pub. Date: Apr. 12, 2007

(54) Method for removing layers from a component

(76) Inventors: Ursus Kruger, Berlin (DE); Daniel Kortvelyessy, Berlin (DE); Ralph Reiche, Berlin (DE); Jan Steinbach, Berlin (DE); Gabriele Winkler, Berlin (DE)

Correspondence Address: Siemens Corporation;Intellectual Property Department, 170 Wood Avenue South, Iselin, NJ, 08830, US

(21) Appl. No.: 10/555,137

(22) PCT Filed: Apr. 8, 2004
(86) PCT No.: PCT/EP04/03818

§ 371 Date: Jan. 4, 2007

(30) Foreign Application Priority Data
May 2, 2003 (EP) 03010059.8

(51) Int. Cl. B23H 3/02

(52) U.S. Cl. 205/641

(57) ABSTRACT

Operationally-stressed components are often returned to use by means of an acid treatment. The duration during which the component remains in the acid is conventionally fixed at a standard value, such that individual stresses are not taken into account. According to the invention, layers may be removed from a component whereby a voltage is at least repeatedly applied to the component, causing a current to flow, the time course of which represents the status of the process of layer removal and which is used to decide the ending or interruption of the acid treatment

The invention relates to a process for removing the coating from a component in accordance with the preamble of claim 1.

Operationally stressed components, such as for example turbine blades or vanes of gas turbines, are subjected to an acid treatment, so that the component can be reused. In the case of gas turbine blades or vanes, the operationally stressed MCrAlY layers on the component are dissolved by being immersed in 20% strength hydrochloric acid at a temperature of approx. 50°-80° C. After a duration determined from empirical values, the blades or vanes are taken out of the acid bath, rinsed with water and then abrasively blasted. The process sequence of acid bath and blasting is repeated a number of times until the entire MCrAlY layer has been removed or dissolved. It is generally necessary to repeat the individual process steps since the acid only dissolves aluminum-containing phases of the MCrAlY layer which are close to the surface. Therefore, lower-lying regions of the MCrAlY layer cannot be dissolved in one step. A porous layer matrix remains on the surface and is subsequently removed mechanically, for example by blasting. The period of time for which the blades or vanes remain in the acid in this case does not reflect the time which is actually required for the individual blade to complete the dissolution process, but rather is set as standard to a specific time. The residence time in the acid bath is in this case generally defined on the basis of general empirical values.

However, each component is subject to different individual stresses, and consequently a fixed stipulation leads to different or incomplete dissolution of the stressed surface. In many cases, the components remain in the acid bath until the predetermined time period has elapsed, without the coating removal actually progressing any further.

Therefore, it is an object of the invention to allow the minimum required dissolution time to be defined individually for each blade or vane (type of coating thickness, state after operational stresses, etc.).

This object is achieved by a process for removing the coating from a component as claimed in claim 1.

In this process, a voltage is from time to time applied to the component and a further pole while the component is located in a coating removal agent, in particular in an acid bath, through which a current is flowing. The time profile of the current, determined from individual measurement points, has characteristic features which reflect the current coating removal state of the component and make it possible to determine an end point for the coating removal process. Therefore, the flow of current can be used to ascertain whether or not the coating removal is actually still in progress. Therefore, this information can be used to decide whether to treat or interrupt the residence of the component in the agent.

The subclaims list further advantageous process steps which can advantageously be combined with one another.

In the drawings:

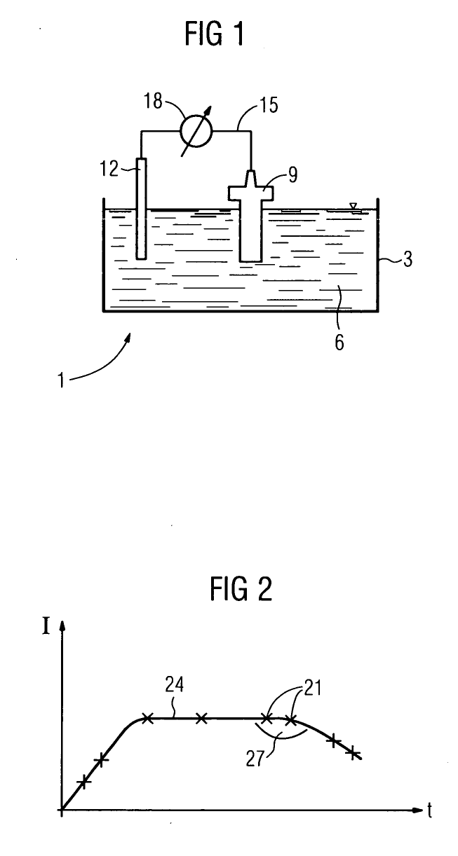

FIG. 1 shows an apparatus for carrying out the process according to the invention, and

FIG. 2 shows a current time profile which is produced when carrying out the process according to the invention.

FIG. 1 shows an apparatus 1 which can be used to carry out the process according to the invention.

The apparatus 1 comprises a vessel 3, for example metallic or ceramic, in which there is arranged an agent 6, an acid 6 or an electrolyte 6, used at least in part to remove the coating from a component 9. The component 9 whereof the surface region is to be dissolved is arranged in the agent 6 or in an acid 6. This dissolution is effected, for example, by the acid attacking the, for example, operationally stressed surface of the component 9. According to the invention, there is a voltage/current source 18, which is electrically connected to the component 9 via connecting means 15. A circuit can be closed by the connecting means 15 being connected to a pole, i.e. an electrode 12 which is arranged in the acid 6, or to the vessel 3, so that a current can flow between component 9 and the pole 3, 12, and this current can also be measured. The current flows via the interior of the component 9 through the stressed surface of the component 9 and through the agent 6 to the electrode 12 or the vessel 3. The current flows discontinuously. For example, therefore, a voltage pulse can be applied at regular and irregular intervals, and the current measured.

A time profile of this type for the current is illustrated in FIG. 2. Initially, the current I rises with time t, then after a certain point in time it is initially substantially constant. The coating removal is not yet complete, i.e. the coating removal rate is still high. After a certain time t, the current I drops. The drop (region or point 27 in the curve I(t)) of the current I indicates that only a small amount of coating material is still being dissolved. The dissolution process can therefore be stopped, for example when a predetermined comparison value for the current intensity has been reached.

Since the measurement voltage is only applied for a very short time, the dissolution process is dominated not by a voltage-initiated electrolysis process, but rather purely by the acid attack.

The time profile of the current I(t) 24 is determined from individual measurement points 21, which are recorded at regular or irregular intervals.

The total measurement time (application of a voltage) required to determine measurement points 21, in relation to the coating removal time, i.e. the time for which the coating is being removed, is 1:100, 1:1000 or 1:10 000, since the voltage is only ever applied for a very short time.

The level of the current or voltage pulse is set in such a way that it has no influence on the process.

Although an electrolyte, for example a dissolved salt, which also produces an acid, may be present in the vessel 3, since there is no permanent or dominant application of current or voltage, an electrolytic process does not take place, and therefore also electrolysis is not involved in the coating removal process.

It is also possible for a plurality of components 9 to be arranged in a vessel 3 for their coating to be removed, in which case a current curve I(t) is determined for each component individually, so that the components can if appropriate remain in the one vessel 3 for different lengths of time. A further component 9 can also be used as a pole 12.

The process can also be carried out in substeps.

In this case, abrasive coating removal, which removes residues of acid products and/or accelerates the coating removal, is in each case carried out in a process intermediate step, since, for example, a brittle layer, which is easier to remove by abrasive means, has formed after the component 9 has remained within the agent 6 for a certain time. It is also possible to wash the component 9 in a process intermediate step. Then, the component 9 is put back in the agent (6). The process steps of treatment of the component 9 in the agent 6, and abrasive blasting, can be repeated as desired. The removal of the coating from the component(s) 9 takes place without the presence of a voltage, i.e. is not effected by an electrolytic coating process.

1-9. (canceled)

10. A process for removing the coating from a component, comprising:
arranging the component in an agent that at least partially chemically attacks the surface of the component;
applying a voltage to the component and a further pole so a current having a time profile flows through the agent; and
using the time profile to decide whether to terminate or interrupt the residence of the component in the agent,
wherein the time profile represents a state of the coating removal process.

11. The process as claimed in claim 10, wherein the further pole used is an electrode in the agent.

12. The process as claimed in claim 10, wherein the agent is an acid.

13. The process as claimed in claim 10, wherein the current rises at the start of the coating removal process and then remains approximately constant.

14. The process as claimed in claim 10, wherein a drop in the current in the time profile marks an end point for the coating removal process.

15. The process as claimed in claim 10, wherein the process is carried out in a plurality of sub-steps, with abrasive coating removal in each case taking place in a process intermediate step and the component then being put back in the agent.

16. The process as claimed in claim 15, wherein during each sub-step an abrasive coating removal takes place in and the component is then put back in the agent.

17. The process as claimed in claim 16, wherein each sub-step is a process intermediate step.

18. The process as claimed in claim 17, wherein the component is rinsed in the process intermediate step.

19. The process as claimed in claim 10, wherein the voltage is pulsed.

20. The process as claimed in claim 10, wherein a vessel is used for the agent and a plurality of components are present in the vessel and an individual time profile is determined for each component.
